(19) United States
(12) Patent Application Publication
(10) Pub. No.: US 2024/0417284 A1
(43) Pub. Date: Dec. 19, 2024

(54) NANOFIBROUS MATERIALS FOR REMEDIATION OF POLY- AND PERFLUOROALKYL SUBSTANCES AND METHODS OF USE THEREOF

(71) Applicant: North Carolina Agricultural and Technical State University, Greensboro, NC (US)

(72) Inventors: Lifeng Zhang, Oak Ridge, NC (US); Shobha Mantripragada, Greensboro, NC (US); Ming Dong, Wilmington, NC (US); Dongyang Deng, Greensboro, NC (US)

(21) Appl. No.: 18/737,017

(22) Filed: Jun. 7, 2024

Related U.S. Application Data
(60) Provisional application No. 63/507,849, filed on Jun. 13, 2023.

(51) Int. Cl. C02F 1/28; B01J 20/24; B01J 20/26; B01J 20/28; C02F 101/36

(52) U.S. Cl. CPC C02F 1/288; B01J 20/24; B01J 20/261; B01J 20/28023; C02F 1/285; C02F 1/286; C02F 2101/36; C02F 2305/08

(57) ABSTRACT

The presently disclosed subject matter relates generally to nanofibrous materials and the use of such materials to remove poly- and perfluoroalkyl substances from a solution.

### CROSS-REFERENCE TO RELATED APPLICATIONS

This application claims priority pursuant to 35 U.S.C. § 119(e) to U.S. Provisional Patent Application Ser. No. 63/507,849 filed Jun. 13, 2023, which is hereby incorporated by reference in its entirety

### FIELD OF THE INVENTION

The presently disclosed subject matter relates generally to nanofibrous materials and the use of such materials to reduce the concentration of poly- and perfluoroalkyl substances (PFAS) in a solution. In particular, the present application discloses sustainable nanofibrous filter/adsorbent materials for short-chain PFAS remediation from aqueous solutions, including water.

### BACKGROUND OF THE INVENTION

Poly- and perfluoroalkyl substances (PFASs) comprise more than 4,000 fully/highly fluorinated aliphatic compounds manufactured for diverse applications. They have been widely used in consumer products such as food packaging, cookware and items commonly found in offices, households, and cars. They are also one of the main components of aqueous film forming foams that are highly effective against hydrocarbon fuel fires and frequently used for firefighting and related training activities.

The carbon-fluorine bond in PFASs is extremely stable under environmental conditions and so PFASs have extremely slow degradation mechanisms. This has resulted in PFAS accumulation in the environment since the beginning of their production in the late 1940s. International concerns regarding the human health from PFAS exposure started in early 2000s; perfluorooctanoic acid (PFOA) has been found in the blood of most Americans. Although additional data are needed to fully understand the impact of PFAS exposure on human health, current research from animal testing indicates that PFASs may be related to cancer, and have direct effects on immunity, metabolism, neurodevelopment, and etc.

The fluorinated carbon chain in PFAS molecule is both hydrophobic and oleophobic while the head group in the chain is easily deprotonated, resulting in high stability of many PFASs in water. The high water solubility of PFASs has led to their accumulation in groundwater, rivers, and oceans. Contamination of drinking water resources has also been documented. The United States Environmental Protection Agency (EPA) proposed a lifetime health advisory level for perfluorooctanesulfonate (PFOS)+PFOA at 70 ng/L in drinking water in 2016. There is an increase of new PFAS production as traditional PFOS and PFOA have been quickly replaced with shorter chain length alternatives. A shorter chain PFOA has been produced with the commercial name “GenX” (name Ammonium 2,3,3,3-tetrafluoro-2-(heptafluoropropoxy) propanoate).

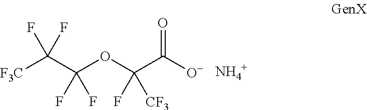 [SMILES: O=C([O-])C(F)(OC(F)(F)C(F)(F)C(F)(F)F)C(F)(F)F ; [NH4+]]

According to the EPA, GenX molecules have similar stability in environment as longer chain PFAS but more mobility than their longer chain counterparts. These molecules have shown health effects on liver, kidney, immune system, etc. upon animal tests.

Direct human exposure to PFASs can be quickly phased out via regulations on chemical production as seen when PFOS was added to the persistent organic pollutants (POPs) list at the Stockholm Convention on Persistent Organic Pollutants in 2009. However, human exposures to the class of compounds in the PFAS family persists due to long-term accumulation of PFAS in the environment. An increase of new PFASs has been reported as industry has quickly replaced traditional PFOS and PFOA with shorter chain length alternatives.

Emerging evidence from animal experiments suggests that short-chain PFASs can be equally or even more hazardous to humans since they have less steric hindrance of their molecules than the longer chain counterparts and consequently higher potential to interact with biomolecules. The technical performance of short-chain PFASs is lower than the long-chain precursors and so larger quantities of short-chain PFASs are being used in commercial production to obtain similar performance as the long-chain counterparts.

The chemical structures of PFASs including the generally high degree of fluorination, the high electronegativity of fluorine, the high strength of the carbon-fluorine (C—F) bond, and ready dissociation of the head group in water lead to extreme stability, low vapor pressure and high water solubility for PFASs. These properties also mean remediating PFASs from water offers a big challenge using current commercial water remediation technologies. To date, remediation of PFASs has focused on the most commonly regulated PFASs: PFOS and PFOA.

The recent regulations and restrictions on use of long-chain PFASs have resulted in a significant shift in industry towards short-chain alternatives. One known PFOA alternative is the ammonium salt of perfluoro-2-propoxypropanoic acid, a perfuoroalkyl ether carboxylic acid (PFECA) that has been produced since 2010 with the trade name “GenX”.

A recent hazard assessment suggested GenX has higher toxicity than PFOA after accounting for toxicokinetic differences. GenX has been detected at high concentration in the Cape Fear River water shed in North Carolina, downstream of a PFAS manufacturing plant. Compared to long chain (generally 8 carbons or longer) PFASs, GenX and other short-chain PFASs have higher aqueous solubility, creating challenges to treating them using conventional remediation and water treatment technologies. That is, for example, systems such as Granular Activated Carbon (GAC) optimized for PFOS removal may not effectively remove GenX and other short-chain PFASs. Concerns have been also raised regarding the potential for short-chain PFASs (four or six carbons) to break through the GAC media. Despite a significant shift in the industry towards short-chain alternatives, there are very limited studies on short- and ultra-short (less than 4 carbons) PFAS.

A wide variety of technologies have been explored to remove or reduce the concentration of PFAS from water, including: dynamic ground water recirculation; precipitation and sedimentation, in which a coagulant adsorbs PFASs via electrostatic and hydrophobic interactions and the precipitate is collected and filtered; foam fraction/ozofractionation in which PFASs are partitioned into microbubbles, which are recovered as foam. Additional systems that have been tried include reverse osmosis and nanofiltration; and ion-exchange resins. GAC has been shown to be highly efficient at removing PFOS, but is less effective at removing shorter chain perfluorocarboxylic acids (PFCAs).

PFAS contamination has proven to be extremely difficult and expensive to remediate and there are few natural or engineered processes that can effectively treat the contamination. Recent development of water treatment for PFASs (typically PFOS and PFOA) falls into two basic categories: destruction and adsorption. Destructive methods include in situ chemical oxidation, electrochemical oxidation, sonolysis, and chemical reduction. Adsorption techniques include GAC, as well as newer materials including cross-linked chitosan beads, various chars, activated carbon fibers, carbon nanotubes, hydrotalcite, Ambersorb, imprinted polymers, modified cotton and rice husk, porous aromatic frameworks, and cross-linked cyclodextrins, to name a few. However, these methods are generally not very efficient or effective, particularly for short chain PFAS, and those that are efficient and effective can be costly.

There is an urgent need to develop novel high-performance adsorbents for PFAS, particularly GenX, remediation from water.

### SUMMARY OF THE INVENTION

As disclosed herein, compositions of the present application have been shown to have improved removal of PFAS, particularly GenX, from water relative to commercially available compositions.

In some aspects, the presently disclosed subject matter provides a method of removing a polyfluoroalkyl or perfluoroalkyl substance (PFAS) from water, the method comprising exposing the PFAS-containing water to a nanofibrous composition comprising algae and/or soy protein, wherein said nanofibrous composition further comprises a polymer, cellulose and/or cellulose acetate. In some aspects, the presently disclosed subject matter provides a method of removing a PFAS from water comprising exposing the PFAS-containing water to a nanofibrous composition comprising polyacrylonitrile and algae. In some aspects, the presently disclosed subject matter provides a method of removing a PFAS from water comprising exposing the PFAS-containing water to a nanofibrous composition comprising a nanofibrous cellulose acetate coated in soy protein and/or nanoprotein and/or a nanofibrous cellulose coated in soy protein.

In some aspects, the presently disclosed subject matter provides a composition comprising a nanofibrous composition comprising algae and/or soy protein, wherein said nanofibrous composition further comprises a polymer, cellulose and/or cellulose acetate. In some aspects, the presently disclosed subject matter provides a nanofibrous composition comprising polyacrylonitrile and algae In some aspects the presently disclosed subject matter provides a nanofibrous composition comprising a nanofibrous cellulose acetate coated in soy protein and/or a nanofibrous cellulose, optionally functionalized, that is coated in soy protein.

These and other embodiments are described in greater detail in the detailed description which follows. An object of the presently disclosed subject matter having been stated hereinabove, and which is achieved in whole or in part by the presently disclosed subject matter, other objects will become evident as the description proceeds when taken in connection with the accompanying drawings as best described herein below.

### BRIEF DESCRIPTION OF THE DRAWINGS

FIG. 1 illustrates SEM images of the example adsorbent materials after filtration of DI water (labeled as 1) and GenX water (labeled as 2) at pH 6: (A) electrospun Polyacrylonitrile nanofibrous membrane (ESPAN); (B) Algae; (C) electrospun PAN/Algae (50/50) nanofibrous membrane (ES (PAN/Algae)).

FIG. 2 shows elemental composition of ESPAN (A) and Algae (B) from EDX spectra with phosphorus (P) element peak marked and P elemental mapping of ES (PAN/Algae) (C) in which P element is marked as magenta color.

FIG. 3 includes optical images of water droplets on ESPAN nanofibrous membrane, Algae particles, and exemplary ES (PAN/Algae) nanofibrous membrane. The SEM image is a high-magnification image of ES (PAN/Algae) nanofibrous membrane showing surface roughness.

FIG. 4 graphs zeta potential of ESPAN nanofibers, Algae particles, and ES (PAN/Algae) nanofibers at pH 4 and 6.

FIG. 5 illustrates GenX removal performance of ESPAN, Algae, and ES (PAN/Algae) with material loading at 0.24 g/L: (panel A) pH effect on GenX removal efficiency of the adsorbent/filter materials; (panel B) material effect on GenX removal efficiency of the adsorbent/filter materials at pH 4 and 6.

FIG. 6 provides FTIR absorption spectra of ESPAN nanofibers (panel A), Algae (panel B), and ES (PAN/Algae) nanofibers (panel C) after filtration with DI water and GenX water, respectively, at pH=6. The filtration with water was used as respective reference. The IR spectra were normalized by the C—H in —CH₂— of respective molecules at 1452-1454 cm⁻¹.

FIG. 7 includes XPS spectra of the ES (PAN-Algae), Algae and ESPAN adsorbents after filtration with water (A) and GenX water (B) at pH 6.

FIG. 8 includes SEM images of nanofibrous adsorbents: (A1) cellulose acetate (CA); (A2) cellulose acetate with soy protein isolate coating (CA-SPI); (B1) cellulose (CE); (B2) cellulose with soy protein isolate coating (CE-SPI). The insets are images with higher magnification.

FIG. 9 is a graph of Zeta potential of nanofibrous membranes comprising SPI, CA, CA-SPI, CE, and CE-SPI.

FIG. 10 illustrates SEM images of nanofibrous adsorbents after GenX adsorption at (A1) CA at pH=4; (A2) CA at pH=6; (B1) CA-SPI at pH=4; (B2) CA-SPI at pH=6; (C1) CE at pH=4; (C2) CE at pH=6; (D1) CE-SPI at pH=4; (D2) CE-SPI at pH=6. The insets are images with higher magnification.

FIG. 11 is a graph of performance of CA and CE nanofibrous adsorbents with and without SPI coating at pH=4 and 6 in GenX removal efficiency.

FIG. 12 depicts an example reaction mechanism of crosslinking cellulose with SPI.

FIG. 13 includes SEM images of CE-SPI (A) and crosslinked CE-SPI (B) before 1st use (labeled as A1 and B1) and after 3rd use (labeled as A2 and B2).

FIG. 14 graphs GenX removal efficiency between dip-coated CE-SPI and crosslinked CE-SPI in 3 cycles.

### DETAILED DESCRIPTION

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular embodiments only and is not intended to be limiting of the invention. All publications, patent applications, patents and other references mentioned herein are incorporated by reference in their entirety. In case of a conflict in terminology, the present specification is controlling.

Also as used herein, “and/or” refers to and encompasses any and all possible combinations of one or more of the associated listed items, as well as the lack of combinations when interpreted in the alternative (“or”).

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a complex comprises components A, B and C, it is specifically intended that any of A, B or C, or a combination thereof, can be omitted and disclaimed.

As used herein, the transitional phrase “consisting essentially of” (and grammatical variants) is to be interpreted as encompassing the recited materials or steps “and those that do not materially affect the basic and novel characteristic(s)” of the claimed invention. See, In re Herz, 537 F.2d 549, 551-52, 190 U.S.P.Q. 461, 463 (CCPA 1976) (emphasis in the original); see also MPEP § 2111.03. Thus, the term “consisting essentially of” as used herein should not be interpreted as equivalent to “comprising.”

It will also be understood that, as used herein, the terms “example,” “exemplary,” and grammatical variations thereof are intended to refer to non-limiting examples and/or variant embodiments discussed herein, and are not intended to indicate preference for one or more embodiments discussed herein compared to one or more other embodiments.

The term “about,” as used herein when referring to a measurable value such as an amount or concentration and the like, is meant to encompass variations of ±10%, ±5%, ±1%, ±0.5%, or even ±0.1% of the specified value as well as the specified value. For example, “about X” where X is the measurable value, is meant to include X as well as variations of ±10%, ±5%, ±1%, ±0.5%, or even ±0.1% of X. A range provided herein for a measurable value may include any other range and/or individual value therein.

With respect to the terms “comprising”, “consisting of”, and “consisting essentially of”, where one of these three terms is used herein, the presently disclosed subject matter can include the use of either of the other two terms.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

Further, when the phrase “up to” is used in connection with an amount or quantity, it is to be understood that the amount is at least a detectable amount or quantity. For example, a material present in an amount “up to” a specified amount can be present from a detectable amount and up to and including the specified amount.

As used herein, the terms “increase,” “increases,” “increased,” “increasing,” “improve,” “enhance,” and similar terms indicate an elevation in the specified parameter of at least about 5%, 10%, 15%, 20%, 25%, 30%, 35%, 40%, 45%, 50%, 55%, 60%, 65%, 70%, 75%, 80%, 85%, 90%, 95%, 100%, 150%, 200%, 300%, 400%, 500% or more such as compared to another measurable property or quantity (e.g., a control value).

As used herein, the terms “reduce,” “reduces,” “reduced,” “reduction,” “inhibit,” and similar terms refer to a decrease in the specified parameter of at least about 5%, 10%, 15%, 20%, 25%, 30%, 35%, 40%, 45%, 50%, 55%, 60%, 65%, 70%, 75%, 80%, 85%, 90%, 95%, 97%, or 100% such as compared to another measurable property or quantity (e.g., a control value). In some embodiments, the reduction can result in no or essentially no (i.e., an insignificant amount, e.g., less than about 10% or even 5%) detectable activity or amount.

As used herein, “nanofibers” or “nanofibrous” refers to fibers (e.g., filaments) with diameters from about 100 nm to about 1000 nm. The nanofibers described herein may be prepared by electrospinning. See, e.g., Xu, et al., Chem. Rev. 2019, 119, 8, 5298-5415; doi:10.1021/acs/.chemrev.8b00593. Alternative methods of preparation of nanofibers are known in the art. See, e.g., Kramar and Gonzalez-Benito, Polymers (Basel), 2022; 14(2):286 (2022); doi:103390/polym14020286. In some embodiments, the nanofibers are characterized by average diameters of no more than about 750 nm, no more than about 500 nm, no more than about 250 nm. In other embodiments, the nanofibers are characterized by average diameters of between about 100 nm to about 250 nm, or between about 100 nm to about 500 nm, or between about 100 nm to about 750 nm, or between about 250 nm and about 750 nm or between about 300 nm and 700 nm or between about 400 nm and about 600 nm. In some embodiments, nanofibers have a diameter of less than 1000 nm, (e.g., a diameter of about 100 nm to about 800 nm).

As used herein, the term “perfluoroalkyl substance” refers to a class of fluorinated hydrocarbon chemicals that are fully fluorinated.

As used herein, the term “polyfluoroalkyl substance” refers to a class of fluorinated hydrocarbon chemicals that are not fully fluorinated.

As an example, PFAS or Poly- and perfluoroalkyl substances can include any compound from a family of fluoralkyl compounds, including but not limited to:

### Carboxylic Acids:

Perfluorotetradecanioc acid (PFTetA): (CAS No.) 376-06-7

### Carboxylic Acids:

Perfluorotridecanoic acid (PFTriA): CAS No. 72629-94-8
Perfluorododecanoic acid (PFDoA): CAS No. 307-55-1
Perfluoroundecanoic acid (PFUnA): CAS No. 2058-94-8
Perfluorodecanoic acid (PFDA): CAS No. 335-76-2
Perfluorononanoic acid (PFNA): CAS No. 375-95-1
Perfluorooctanoic acid (PFOA): CAS No. 335-67-1
Perfluoroheptanoic acid (PFHpA): CAS No. 375-85-9
Perfluorohexanoic acid (PFHxA): CAS No. 307-24-4
Perfluoropentanoic acid (PFPeA): CAS No. 2706-90-3
Perfluorobutanoic acid (PFBA): CAS No. 375-22-4
Perfluoropropanoic acid (PFPrA): CAS No. 422-64-0

### Sulfonates/Sulfonic Acids:

Perfluorodecyl sulfonate (PFDS): CAS No. 335-77-3 as acid
Perfluorononane sulfonate (PFNS): CAS No. 68259-12-1 as acid
Perfluoroocytl sulfonate (PFOS): CAS No. 1763-23-1
Perfluoroheptyl sulfonate (PFHpS): CAS No. 375-92-8 as acid
Perfluorohexyl sulfonate (PFHxS): CAS No. 355-46-4 as acid
Perfluoropentanesulfonic acid (PFHeS): CAS No. 2706-91-4
Perfluorobutyl sulfonate (PFBS): CAS No. 375-73-5 as acid
Perfluoropropane sulfonate (PFPrS): CAS No. 110676-15-8

### Sulfonamides:

Perfluorooctanesulfonamide (PFOSA): CAS No. 754-91-6
Perfluorohexanesulfonamide (PFHxSA): CAS No. 41997-13-1
Perfluorobutylsulfonamide (PFBSA): CAS No. 30334-69-1
8:2 Chlorinated perfluoroether sulfonic acid (8:2 CI-PFESA): CAS No. 83329-89-9
6:2 Chlorinated perfluoroether sulfonic acid (6:2 CI-PFESA): CAS No. 73606-19-6

### Other PFASs (Including Precursors, Degradation Products, and Substitutes):

Perfluoro-4-methoxybutanoic acid (PFMOBA): CAS No. 863090-89-5
Difluoro(perfluoromethoxy)acetic acid, also known as perfluoro-2-methoxyacetic acid (PFMOAA): CAS No. 674-13-5
Perfluoro-3-methoxypropanoic acid (PFMOPrA): CAS No. 377-73-1
Perfluoro-3,5,7,9-butaoxadecanoic acid (PFO4DA): CAS No. 39492-90-5
Perfluoro-3,5,7-trioxaoctanoic acid (PFO30A): CAS No. 39492-89-2
Perfluoro-3,5-dioxahexanoic acid (PFO2HxA): CAS No. 39492-88-1
Fluorotelomer sulfonate 8:2 (FtS 8:2): CAS No. 39108-34-4
Fluorotelomer sulfonate 6:2 (FtS 6:2): CAS No. 27619-97-2
Fluorotelomer sulfonate 4:2 (FtS 4:2): CAS No. 414911-30-1
8:2 Fluorotelomer alcohol (8:2 FTOH): CAS No. 678-39-7
6:2 Fluorotelomer alcohol (6:2 FTOH): CAS No. 647-42-7
4:2 Fluorotelomer alcohol (4:2 FTOH): CAS No. 2043-47-2
6:6 Perfluorophosphinic acid (6:6 PFPiA): CAS No. 40143-77-9
6:8 Perfluorophosphinic acid (6:8 PFPiA): CAS No. 610800-34-3,3,4,4,5,5,6,6,7,7,8,8,9,9,10,10,10-Heptadecafluordecylacrylate (8:2 FTAC): CAS No. 27905-45-9
(Perfluorohexyl)ethylene (6:2 FTO): CAS No. 25291-17-2 Perfluorohexyl iodide (PFHxl): CAS No. 355-43-1
1,1,1,2,2,3,3,4,4,5,5,6,6-Tridecafluoro-8-iodooctane (6:2 FTI): CAS No. 2043-57-4
3,3,4,4,5,5,6,6,7,7,8,8,8-Tridecafluoro-1-iodooct-1-ene (TIFE): CAS No. 150223-14-6
1,1,1,2,2,3,3,4,4,5,5,6,6-Tridecafluoro-8-iodooctane (6:2 FTI): CAS No. 2043-57-4
2-(N-Ethyl-perfluorooctanesulfonamido)acetate (N-EtFOSAA): CAS No. 2991-50-6
2-(N-Methylperfluorooctanesulfonamido)acetate (N-MeFOSAA): CAS No. 909405-48-7, CAS No. 2355-31-9 as acid
Ammonium 4,8-dioxa-3H-perfluorononanoate (ADONA): CAS No. 958445-44-8, CAS No. 919005-14-4 as acid
Perfluoro-4-(perfluoroethyl)cyclohexylsulfonate (PFECHS): CAS No. 80988-54-1
F-53B: a combination of 9-chlorohexadecafluoro-3-oxanone-1-sulfonic acid (CAS No. 756426-58-1) and 11-Chloroeicosafluoro-3-oxaundecane-1-sulfonic acid (CAS No. 763051-92-9)
Perfluoro-2-{[perfluoro-3-(perfluoroethoxy)-2-propanyl]oxy}ethanesulfonic acid, also known as Nafion BP2: CAS No. 749836-20-2
Hexafluoropropylene oxide-dimer acid (HFPO-DA): CAS No. 62037-80-3 as ammonium salt, CAS No. 13252-13-6 as acid
Hexafluoropropylene oxide trimer acid (HFPO-TA): CAS No. 13252-14-7
Hexafluoropropylene oxide tetramer acid (HFPO-TeA): CAS No. 27639-98-1

When used herein “GenX” refers to hexafluoropropylene oxide-dimer acid and/or its salt, wherein the salt is selected from the group of ammonium, diethanolamine, potassium, and lithium. In some embodiments, the salt is the ammonium salt.

As used herein, “soy protein” refers to a protein that is isolated from soybean. In some instances, the soy protein is an isolate. Soy protein isolate is a purified form of soy protein, typically containing a minimum protein content of about 90% on a moisture-free basis. Generally, soy protein isolate (SPI) is made from defatted soy flour which has had most of the non-protein components, fats and carbohydrates removed, for example, 70%, 71%, 72%, 73%, 74%, 75%, 76%, 77%, 78%, 79%, 80% 81%, 82%, 83%, 84%, 85%, 86%, 87%, 88%, 89%, 90% or more of the non-protein components, fats and carbohydrates removed.

As used herein, “remove” refers to partial, substantial, or complete removal of the specified component from the specified stream or aqueous source. Accordingly, 10%, or 20%, or 30%, or 40%, or 50%, or 60%, or 70%, or 80%, or 90%, or 95%, or 96%, or 97%, or 98%, or 99% by mass of the specified component may be removed from the specified stream or aqueous source, for example, removal of PFAS from an aqueous solution, particularly removal of short chain PFAS such as GenX from water.

The present application provides remediation compositions that have use in the remediation of PFAS, including but not limited to GenX, a method making such composition(s), a method of using such composition(s), and a remediation system including such composition(s).

Provided herein are compositions comprising a polymer nanofiber selected from polyacrylonitrile, polystyrene, cellulose, and cellulose acetate, and combinations thereof. In some embodiments, the cellulose nanofibers are (3-glycidyloxypropyl) trimethoxysilane (GPTMS)-functionalized.

In some aspects, the presently disclosed subject matter provides a composition comprising a nanofibrous composition comprising algae and/or soy protein, wherein said nanofibrous composition further comprises a polymer, cellulose and/or cellulose acetate.

In some aspects, the presently disclosed subject matter provides a nanofibrous composition comprising polyacrylonitrile and algae.

In some aspects the presently disclosed subject matter provides a nanofibrous composition comprising a nanofibrous cellulose acetate coated in soy protein and/or a nanofibrous cellulose coated in soy protein isolate. In some embodiments, the cellulose nanofibers are functionalized to increase hydrophobicity and/or decrease hydrophilicity, for example, using a linker that increases hydrophobicity of the cellulose nanofibers. In some embodiments, the cellulose nanofibers are (3-glycidyloxypropyl) trimethoxysilane (GPTMS) functionalized.

In some embodiments, the nanofibers are coated in soy protein isolate. In some embodiments, the nanofibers comprising soy protein isolate are cellulose nanofibers. In some embodiments, the cellulose nanofibers are functionalized and may be configured to (e.g., capable of) chemically bonding soy protein isolate. In an example embodiment, the cellulose nanofibers are GPTMS-functionalized.

In some embodiments, the nanofibers comprise cellulose and/or cellulose acetate, optionally coated with soy protein, are used to develop innovative adsorbents for PFAS, particularly GenX, to reduce the concentration of PFAS in water.

In some embodiments disclosed herein, the nanofibrous composition comprises electrospun cellulose or electrospun cellulose acetate. In some variations, the nanofibrous composition comprises cellulose acetate nanofibers; in some variations, the nanofibrous composition comprises cellulose nanofibers.

In some embodiments, the nanofibrous composition is capable of remediating or removing PFAS from water at an increased removal capacity (e.g., removal rate) relative to a standard filtration composition.

In some embodiments, the increased removal capacity is relative to a commercially available activated carbon composition, for example, granular activated carbon (GAC) or powdered activated carbon (PAC). In some embodiments, the compositions provided herein provide improved removal efficiency of GenX in water relative to commercially available compositions, for example, granulated activated carbon. In some embodiments, the increased removal capacity is at least 10%, 15%, 20%, 25%, 30%, 35% or 40% higher than a commercially available activated carbon composition for a PFAS constituent, for example a short chain or ultrashort chain PFAS, e.g., GenX.

### Methods of Preparing the Nanofiber Compositions

Nanofibers described herein can be made in any manner not inconsistent with the objectives of the present disclosure. Example methods of making nanofibers are provided in the working examples of the present invention. The nanofibers may be made by electrospinning as detailed herein, and/or by methods known in the art. See, e.g., Xu, et al., Chem. Rev. 2019, 119, 8, 5298-5415; doi:10.1021/acs/.chemrev.8b00593. Alternative methods of preparation of nanofibers are known in the art. See, e.g., Kramar and Gonzalez-Benito, Polymers (Basel), 2022; 14(2):286 (2022); doi:1 03390/polym14020286.

In some embodiments, the nanofiber is prepared by electrospinning a spin dope comprising algae and a polymer. In some embodiments, the polymer is polyacrylonitrile or polystyrene. In some embodiments, the algae has a protein content of at least about 50%. In some embodiments, the algae is Chlorella or is Spirulina. In some variations, the algae is a dried powder and the polymer is polyacrylonitrile or is polystyrene that is electrospun.

In an embodiment, a nanofibrous polyacrylonitrile and algae product can be prepared from electrospinning a spin dope comprising polyacrylonitrile and algae. In some embodiments, the algae powder can have an average particle size of between about 0.5 microns and 3000 microns, or any range therein, for example, 0.5 to 10, 0.5 to 100, 50 to 2000, 50 to 1500, 50 to 1000, 50 to 800, 50 to 600, 100 to 3000, 100 to 2000, 100 to 1500, 100 to 1000 or 100 to 800 microns. In an example embodiment disclosed herein, powdered Chlorella algae is used. In some embodiments, algae having high protein content, generally above 50%, can be used and/or substituted for Chlorella, such as for example, Spirulina. Algae can be dispersed in a solvent, for example, with sonication, that can then be introduced into a solution of PAN. The PAN/Algae solution can comprise a 40/60 wt/wt, to 60/40 wt/wt solution, including, for example, a 50/50 wt/wt PAN/Algae solution. The PAN/Algae solution can be mixed to make a homogenous solution and then electrospun.

In some embodiments, nanofibrous cellulose acetate (CA) and nanofibrous cellulose (CE) can be prepared via electrospinning. In some embodiments, soy protein isolate can be used to coat the CA nanofiber or CE nanofiber surface, for example, by exposing the nanofibers to the soy protein isolate. In some variations, the coating is applied by dip coating the nanofibers in a solution of the soy protein isolate. In some embodiments, the dip coating can be performed at room temperature. In some embodiments, dip coating can be performed with heat, for example at a temperature between 100° C. and 110° C., or any range therein, for example, 105° C. In some embodiments, the cellulose nanofibers are functionalized to increase hydrophobicity and/or decrease hydrophilicity, for example, using a linker that increases hydrophobicity of the cellulose nanofibers. In some embodiments, the cellulose nanofibers are (3-glycidyloxypropyl) trimethoxysilane (GPTMS) functionalized. In some embodiments, functionalization can be according to Zhang et al., “Soy protein isolate-based films reinforced by surface modified cellulose nanocrystal,” Industrial Crops and Products, 80, 207-213, February 2016, incorporated herein by reference.

### Methods of Using the Nanofiber Compositions

In some embodiments, the presently disclosed subject matter provides a method of removing a polyfluoroalkyl and/or perfluoroalkyl substance (PFAS) from water comprising exposing the PFAS-containing water to a nanofibrous composition comprising algae and/or soy protein, wherein said nanofibrous composition further comprises a polymer, cellulose and/or cellulose acetate. In some embodiments, the presently disclosed subject matter provides a method of removing a PFAS from water comprising exposing the PFAS-containing water to a nanofibrous composition comprising polyacrylonitrile and algae. In some embodiments, the presently disclosed subject matter provides a method of removing a PFAS from water comprising exposing the PFAS-containing water to a nanofibrous composition comprising a nanofibrous cellulose acetate coated in soy protein and/or a nanofibrous cellulose coated in soy protein. As disclosed herein, the nanofibrous adsorbents of a variety of compositions, including electrospun polystyrene, electrospun polyacrylonitrile (PAN), electrospun PAN/algae, electrospun CE and electrospun CA, as well as soy protein coated CE nanofibers soy protein coated functionalized CE nanofibers, and soy protein coated CA nanofibers, are effective for the removal or reduction of PFAS, particularly short chain PFAS such as GenX, from aqueous solutions.

In some embodiments, a nanofibrous filter/adsorbent materials to remediate GenX from water, for example, nanofibrous materials comprising cellulose (CE) and/or its derivative cellulose acetate (CA), are renewable and/or can be utilized multiple times for removing GenX and other PFAS constituents from water. In some embodiments, nanofibrous membranes coated with soy protein isolate (SPI) yield highly effective filter/adsorbent materials for GenX remediation from water. In some examples, introduction of an SPI coating to CA and/or CE nanofibrous membranes greatly promoted, e.g., increased, GenX removal efficiency from water. In some example embodiments, GenX removal capacity is at least 0.8 mmol/g, at least 0.9 mmol/g, at least 1 mmol/g, or at least ˜1.1 mmol/g of nanofiber composition. In some embodiments, the GenX removal capacity is higher than that of commercially available or published GenX adsorbents. In some embodiments, the nanofibrous materials have 40% higher removal capacity than reported for adsorbents comprising activated carbon.

In some embodiments, the nanofibrous composition removes at least about 50% of one or more PFAS from an aqueous solution containing PFAS. In some embodiments, the composition removes at least about 75%, or at least about 85% or at least about 88%, or at least about 90%, or at least about 95%, or at least about 99% of PFAS (e.g., GenX) from an aqueous solution containing PFAS. In some embodiments, the adsorption capacity is measured in a 100 ppm PFAS (e.g., GenX) solution. In some embodiments, where GenX is present at a lower concentration, for example, less than 100 ppm, e.g., 50 ppm, 10 ppm, or 1 ppm, the nanofiber composition can remove at least about 90%, or at least about 92%, or at least about 95%, or at least about 97%, or at least about 99% of PFAS (e.g., GenX) from the solution. In some embodiments, the method can comprise exposing PFAS-containing water to a nanofiber composition as described herein, adsorbing the PFAS with the nanofiber composition, rinsing the PFAS from the nanofiber composition, and repeating the steps of adsorbing and rinsing. In some embodiments, the nanofiber compositions according to some embodiments can be re-used for multiple (e.g., 2, 3, 4, 5, 6, 7, 8, 9, 10 or more) rounds of adsorption.

In some variation of any aspect disclosed herein, the PFAS comprises an ultra-short chain PFAS having less than 4 carbons in its chemical formula, a short chain PFAS having 4-6 carbons in its chemical formula, or a long chain PFAS, having more than 6 carbons in its chemical formula. In some variations, the PFAS comprises an ultra-short chain PFAS having less than 4 carbons in its chemical formula. In some variations, the PFAS comprises a short chain PFAS having 4-6 carbons in its chemical formula; in other variations, the PFAS comprises a long chain PFAS, having more than 6 carbons in its chemical formula.

In some variation of any aspect disclosed herein, the PFAS is selected from the group of Hexafluoropropylene oxide-dimer acid, Hexafluoropropylene oxide-dimer salt, Hexafluoropropylene oxide-trimer acid, Hexafluoropropylene oxide-trimer salt, Hexafluoropropylene oxide-tetramer acid, Hexafluoropropylene oxide-tetramer salt, Perfluorooctanoic acid, Perfluorooctanoate salt, Perfluorooctyl Sulfonate, and Perfluorooctyl Sulfonic acid. In some variations, the PFAS is selected from Hexafluoropropylene oxide-dimer acid, Hexafluoropropylene oxide-dimer salt, Hexafluoropropylene oxide-trimer acid, Hexafluoropropylene oxide-trimer salt, Hexafluoropropylene oxide-tetramer acid, and Hexafluoropropylene oxide-tetramer salt. In some variations, the PFAS is selected from Hexafluoropropylene oxide-dimer acid and Hexafluoropropylene oxide-dimer salt. In some variations, the PFAS is selected from Hexafluoropropylene oxide-trimer acid and Hexafluoropropylene oxide-trimer salt. In some variations, the PFAS is selected from Hexafluoropropylene oxide-tetramer acid and Hexafluoropropylene oxide-tetramer salt. In some variations, the PFAS is selected from Perfluorooctanoic acid, Perfluorooctanoate salt, Perfluorooctyl Sulfonate, and Perfluorooctyl Sulfonic acid. In some variations, PFAS is selected from Perfluorooctanoic acid and Perfluorooctanoate salt. In some variations, the PFAS is selected from Perfluorooctyl Sulfonate and Perfluorooctyl Sulfonic acid.

In some variations, the salt is selected from the group of ammonium, diethanolamine, potassium, and lithium; in some variations, the salt is ammonium; in some variations the salt is diethanolamine.

Generally, a method of remediating and/or removing PFAS, such as GenX, from water comprises filtration. Such filtration can be by gravity, using pressure, for example via pumping, or by vacuum. Such filtration can be used in combination with other purification or remediation processes known to those of skill in the art. In some embodiments, the nanofibers incorporating algae and/or cellulose (CE) and/or its derivative cellulose acetate (CA) provide a synergistic effect providing significantly improved removal efficiency of a PFAS (e.g., GenX) relative to a nanofiber (e.g., PAN), algae, CE, or CA alone.

In some embodiments, the aqueous solution is water, in some instances the water is ground water, in some instances the water is well water, in some instances the water is in a stream, creek, and/or river. In some embodiments, the water is an industrial wastewater source, for example, effluent resulting from a manufacturing process.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### Example 1

As a short-chain PFAS (per- and polyfluoroalkyl substances), GenX was produced in recent years to replace the traditional long-chain PFAS such as perfluorooctanoic acid (PFOA). However, GenX turns out to be more toxic than people originally thought, posing health risks as a persistent environmental pollutant. In this research, for the first time, Chlorella, a single-celled green freshwater microalga that grows worldwide, was incorporated with polyacrylonitrile (PAN) in equal amount in electrospun nanofibers and the capability of the electrospun PAN/Algae bicomponent nanofibrous membrane (ES (PAN/Algae)) to bind and remove GenX from water was studied. The incorporation of algae demonstrated synergistic effect and significantly improved the GenX removal efficiency of the nanofibrous membrane. The maximum GenX removal capacity reached 0.9 mmol/g at pH 6, which is significantly higher than that of most of reported GenX adsorbents as well as activated carbon. The GenX removal mechanism was investigated and discussed by using water contact angle, zeta potential, FTIR, and XPS techniques. The materials described herein can be used to make highly efficient adsorbent/filter materials from common and economic materials to practically remediate short-chain PFAS from various water bodies.

### Materials

Polyacrylonitrile (PAN, MW=150,000) and N, N-Dimethylformamide (DMF, 99%) were purchased from Sigma-Aldrich. Chlorella powder (algae) was purchased from Nuts.com. GenX was purchased from Synquest laboratories. All materials were used as received without further processing. Type 1 Deionized (DI) water was used from a Millipore DI water system.

### Preparation of Electrospun Nanofibers

Chlorella powder (the Algae) was weighed and finely dispersed into DMF solvent through 30 min sonication and then introduced into a PAN-DMF solution to make a DMF solution of PAN/Algae (50/50, wt./wt.) at a total concentration of 10 wt. %. The solution was continuously stirred for another 24 hrs to make a homogenous solution for electrospinning. The electrospinning solution was loaded into a 10 ml syringe which was connected to an 18 g blunt end needle. The electrospinning was carried out by applying 18 kV positive voltage. Electrospun nanofibers were collected on a metal plate that was 15 cm away from the tip of spinning needle and covered with aluminum foil. PAN nanofibrous membrane was also prepared by electrospinning a 10 wt. % PAN-DMF solution and used as a control. The as-spun fibers were placed in fume-hood to evaporate the remaining solvent and then kept in a desiccator for later use.

### Preparation of GenX Water

The GenX water for adsorption tests was prepared by dissolving 100 mg GenX in 1 L Type 1 DI water. The pH of the solution was measured by using an Orion pH meter and adjusted by using diluted HCl or NaOH solution. Two pHs (pH 4 and 6) were studied in this research.

### Characterization

Surface morphology of the nanofibrous membrane was examined by a Zeiss Auriga FIB scanning electron microscope (SEM). Before analyzing, the SEM samples were sputter-coated with gold-palladium at a thickness of 8 nm to avoid surface charge accumulation. Elemental mapping was performed through an energy-dispersive X-ray spectrometer (EDX) that is equipped with the SEM. Average fiber diameter of respective nanofiber sample was obtained by measuring diameters of 30 randomly selected nanofibers in corresponding SEM images using Image J software. Chemical bonding in the nanofibrous membranes was characterized by attenuated total reflectance (ATR)-FTIR spectroscopy via an Agilent Varian 670 FTIR-ATR spectrometer using dry samples. Surface charge of the nanofibers was determined in DI water at pH 4 and 6 by a Malvern Zeta Sizer ZEN3600 dynamic light scattering (DLS) instrument. Surface property (water contact angle) of the nanofibrous membranes was assessed by a Rame Hart 260-F4 tensiometer. Surface elemental composition and bonding of the nanofibrous membranes was studied through an X-ray photon spectroscopy (XPS, Thermo Scientific Escalab Xi+). Advantage software was used to process the data. The curve fitting of individual element was done using a combination of Gaussian-Lorentz equations. All XPS spectra were charge-corrected by using Cis binding energy of 284.8 eV.

### GenX Sorption Test

Each GenX sorption test was carried out by using 100 mL 100 mg/L GenX water at pH 4 and 6. The GenX adsorption efficiency of all the nanofibrous membranes was accessed at room temperature by a filtration setup as reported in our previous research S. Mantripragada et al, “Remediation of GenX from water by amidoxime surface-functionalized electrospun polyacrylonitrile nanofibrous adsorbent,” Chemosphere, 2021, vol. 283, p. 131235, November 2021). 0.024 g PAN/Algae bicomponent nanofibrous membrane as well as PAN nanofibrous membrane as control was weighed, respectively, and cut into circular shapes to seamlessly cover the bottom of filtering funnel as filtration medium. The control filter medium of algae was prepared by placing 0.012 g raw algae particles on top of 0.012 g PAN nanofibrous membrane that fit the bottom of filtering funnel. The reason for preparing this control is because of the pass-through loss of raw algae particles in filtration through holes on the bottom of filtering funnel when they are directly applied.

Once the respective nanofibrous filter material was appropriately placed, 100 mL GenX water was poured into the funnel and allowed to flow through the nanofibrous filter via gravity. 10 ml of the filtered solution was taken, placed into a polypropylene (PP) centrifuge tube, and then subjected to centrifuge at 10,000 rpm for 30 min to remove possible nanofiber leftover in solution. Then 1 ml of the supernatant was taken and transferred to a quartz cuvette for GenX concentration measurement using a Varian Cary 6000i UV-Vis spectrometer with wavelength set from 175 nm to 400 nm. A calibration curve was established based on the UV adsorption at 189-190 nm wavelength with GenX concentrations ranging from 10 to 100 mg/L. A control UV absorbance of respective filter membrane was acquired using DI water (without GenX) that went through the filtration setup under the same condition.

The percentage removal of GenX was calculated using equation (1)

$$\% GenX removal = \frac{{C}_{i} - {C}_{f}}{{C}_{i}} \times 100 \qquad 1 )$$

where Cᵢ and C_{f} are the initial and final GenX concentrations. For each sample, the adsorption test was performed three times and results were reported as an average ±standard deviation.

### Results and Discussion

### Morphology

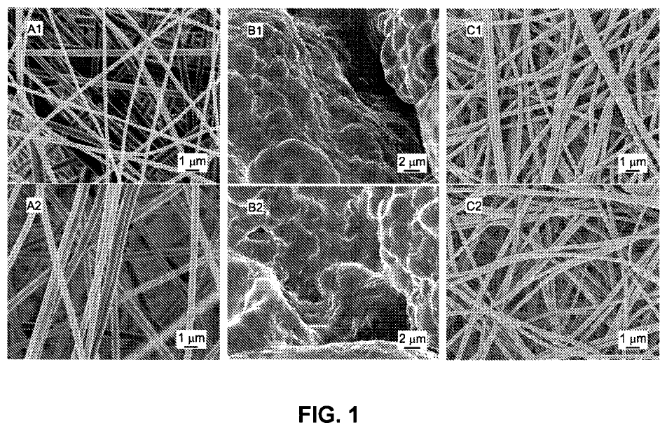

The morphology of three adsorbent materials, i.e., the electrospun PAN/Algae (50/50) nanofibrous membrane (ES (PAN/Algae)) along with two controls: the electrospun PAN nanofibrous membrane (ESPAN) and the algae particles on electrospun PAN nanofibrous membrane (Algae), were characterized by SEM after filtration with DI water and 100 mg/L GenX water (FIG. 1). ESPAN showed smooth surface with an average diameter of 522±32 nm. ES (PAN/Algae) exhibited a rough surface with an average diameter of 295±23 nm, which is approximately 43% smaller than that of PAN nanofibers. Algae appeared as merged/agglomerated particles with sizes 2 to 5 microns. After GenX adsorption, all the nanofibrous membranes retained their nanofibrous structure. ESPAN nanofibers did not show an appreciable change in their diameter, but the average size of ES (PAN/Algae) nanofibers increased ˜28% to 378±32 nm. In the case of Algae, the particles shrunk a little bit, and their surface roughness is slightly reduced. Both the diameter changes of ES (PAN/Algae) nanofibers and the morphology change of algae particle surface indicated an interaction between algae and GenX.

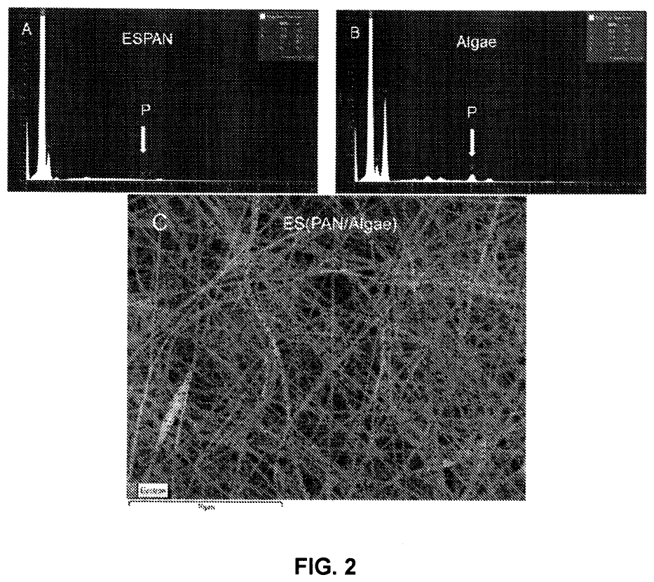

To characterize algae distribution in ES (PAN/Algae), Phosphorus (P) elemental mapping through EDX that is equipped with the SEM was used. PAN does not contain any P element (FIG. 2A) but P is an essential element in algae (FIG. 2B). The P elemental mapping of ES (PAN/Algae) nanofibrous membrane revealed that small algae pieces from raw algae particles due to sonication processing was indeed integrated with PAN in the electrospun nanofibers as submicrometer domains and distributed uniformly in PAN matrix.

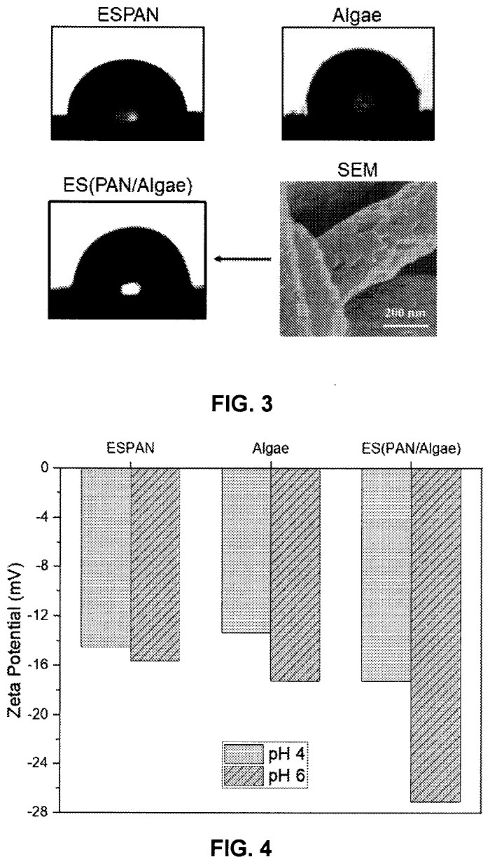

To characterize surface property of the adsorbent/filter materials, water contact angle measurement was carried out and optical observations of water droplets on respective material surface are shown in FIG. 3. It was observed that ESPAN nanofibrous membrane was hydrophobic (water contact angle 103±6.5°) which was in agreement with previous research (Sirelkhatim et al, “Antifungal activity of amidoxime surface functionalized electrospun polyacrylonitrile nanofibers,” Materials Letters, 2015, vol. 141, pp. 217-220, February 2015) while the Algae showed less hydrophobic surface property (water contact angle 86±1.4°). ES (PAN/Algae) nanofibrous membrane exhibited less hydrophobicity (water contact angle 75±1.4°). The smaller water contact angle could be attributed to surface roughness of ES (PAN/Algae) nanofibers, a result from the integration of small algae pieces (FIG. 2C), as shown in the high-magnification SEM image of FIG. 3 due to the enhancement of wettability by surface roughness according to Wenzel equation.

### Zeta Potential

Surface charges of the three adsorbent/filter materials were evaluated by DLS at pH 4 and 6 (FIG. 4). It was observed that all these materials possessed a negative charge irrespective of pHs. ESPAN nanofibers were negatively charged at pH 4 and became slightly more negatively charged with the increase of pH to 6, which is consistent with previous published research (Cho et al, “Characterizing zeta potential of functional nanofibers in a microfluidic device,” Journal of Colloid and Interface Science, 2012, 372, 252-260) and could be attributed to less protonation of the very polar nitrile functional groups from pH 4 to 6. Algae also possessed a negative charge due to the presence and balance of large number of functional groups on surface of algal cell wall such as ionized carboxylic and amine functional groups (Gupta et al, “Biosorption-a green method for the preconcentration of rare earth elements (REEs) from waste solutions: a review,” Journal of Molecular Liquids, 2019, 274, 148-164). With the increase of pH, the zeta potential of Algae became more negative, which is consistent with previous reports (Hadjoudja et al, “Cell surface characterisation of Microcystis aeruginosa and Chlorella vulgaris,” Journal of Colloid and Interface Science, 2010, 342, 293-299); Vandamme et al, “Flocculation as a low-cost method for harvesting microalgae for bulk biomass production,” Trends in Biotechnology, 2013, 31, 233-239). This can be ascribed to the increase of (—COO—) and decrease of (—NH₃+) on algal surface at higher pH value. Compared to ESPAN nanofibers and algae particles, ES (PAN/Algae) nanofibers showed more negative charges at respective pH and the same trend as pH increased. At pH 6, the most negative zeta potential (−27.1 mV) among all the studied adsorbent materials was observed from ES (PAN/Algae) nanofibers. The sonification of algae in solvent as well as the electrospinning process should have broken algal cell wall and made more negative-charged algal surface be exposed to water in the case of ES (PAN/Algae) nanofibers, as confirmed by the P element mapping in FIG. 2C.

GenX Remediation from Water

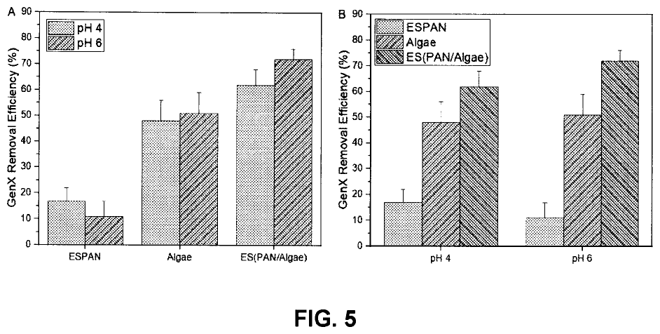

Quantitative adsorption of GenX on all the studied adsorbent/filter materials was carried out by using UV absorption (FIG. 5). A calibration curve of GenX was acquired in the concentration ranges of 10 to 100 mg/L at pH 4 and 6, respectively, with a linear fitting coefficient of determination R²=0.99.

The GenX removal efficiency of ESPAN nanofibrous membrane at pH 4 is ˜17%, approximately 50% higher than that at pH 6. Algae, i.e., the control sample with raw algae particles on top of ESPAN membrane at 50/50 weight ratio, showed a much higher GenX removal efficiency of ˜50% regardless of pH. The maximum GenX removal efficiency from 100 mL of 100 mg/L GenX water was observed with the ES (PAN/Algae) nanofibrous membrane, which is ˜72% at pH 6 while lower pH (pH 4) reduced GenX removal performance a little bit to ˜62%. The 72% GenX removal efficiency indicated that the nanofibrous filter/adsorbent membrane reached its capacity with this filtration setup. To verify this, the GenX removal efficiency of the nanofibrous membrane with 200 mL of 100 mg/L GenX water was tested and a reduced GenX removal efficiency to 38%, which is slightly higher than half of 72% from the 100 mL GenX water was observed. This could be attributed to longer residence time of GenX water in the funnel of filtration setup, which increased possible contact time between GenX molecules and ES (PAN/Algae) nanofibrous membrane to make it close further to the ultimate GenX adsorption capacity. The observed maximum GenX removal capacity (weight normalized GenX removal) was ˜0.9 mmol/g, which is significantly higher than that of ESPAN nanofibrous membrane and even the amidoxime surface-functionalized ESPAN nanofibrous membrane as shown in our previous research as well as that of most published GenX adsorbents along with activated carbon (Mantripragada et al, “Addressing short-chain PFAS contamination in water with nanofibrous adsorbent/filter material from electrospinning,” Accounts of Chemical Research, 2023, 56, 1271-1278). It is noteworthy that integration of algae in ESPAN nanofibers at 50 wt. % (0.012 g algae with 0.012 g PAN in the nanofibrous membrane) could not only improve GenX removal from the 100 mL 100 mg/L GenX water at pH 6 by 6.5 times compared to that of the ESPAN nanofibrous membrane (0.024 g), but also improve the GenX removal by 40% compared to the control Algae (0.012 g raw algae particles on top of 0.012 g ESPAN nanofibrous membrane), indicating an exciting synergistic effect from the integration of algae within PAN nanofibers. This could be attributed to the breakup of raw algae particles and there was more algal surface be exposed to water in the case of ES (PAN/Algae) nanofibrous membrane.

### GenX Removal Mechanism

The GenX removal mechanism from water by ES (PAN/Algae) nanofibrous membrane was further studied by FTIR and XPS analysis. pH 6 was used in this part of research because it was the pH of GenX water and the ES (PAN/Algae) nanofibrous membrane showed the best adsorption performance at this pH.

### FTIR Analysis

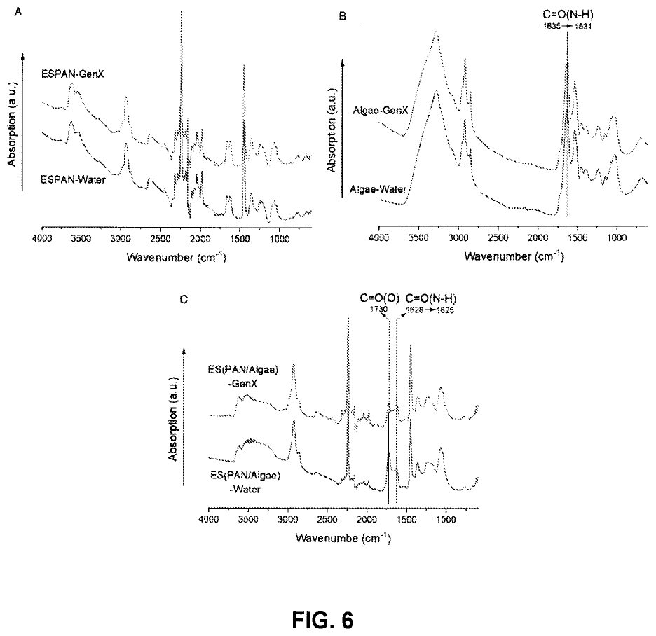

FTIR was used to characterize the interaction between adsorbents and GenX (FIG. 6). In the GenX adsorption test, a control was performed by testing respective adsorbent with DI water (no GenX). There is no appreciable change in the FTIR spectra of ESPAN nanofibrous membrane after GenX adsorption (FIG. 6, panel A). Algae particles showed an amide (I) (C═O(N—H)) band centered at 1635 cm⁻¹ from their protein component and the amide band slightly shifted to 1631 cm⁻¹ after GenX adsorption (FIG. 6, panel B), suggesting weakened C═O bond due to strong polar C—F bond of GenX nearby.

Compared to algae alone, the algae in ES (PAN/Algae) nanofibers showed a weakened amide I band, and the absorption peak shifted from 1635 cm⁻¹ to 1628 cm⁻¹. This indicated that the strong polar nitrile groups (C—N) in PAN molecules interacted with the C═O in amide (I) bond in algal protein component and resulted in smaller dipole moment and force constant (FIG. 6 panels B &C). After GenX adsorption, the amide (I) band in ES (PAN/Algae) nanofibers shifted from 1628 cm⁻¹ to 1625 cm⁻¹ (FIG. 6, panel C), exhibiting a similar C—F bond effect on C═O as shown in algae particles. It is noteworthy that the C═O in ester bond (C═O(O)) was also weakened after GenX adsorption, suggesting the strong polar C—F bond from GenX also interacted with the ester bonds from the lipid component of algae.

### XPS Analysis

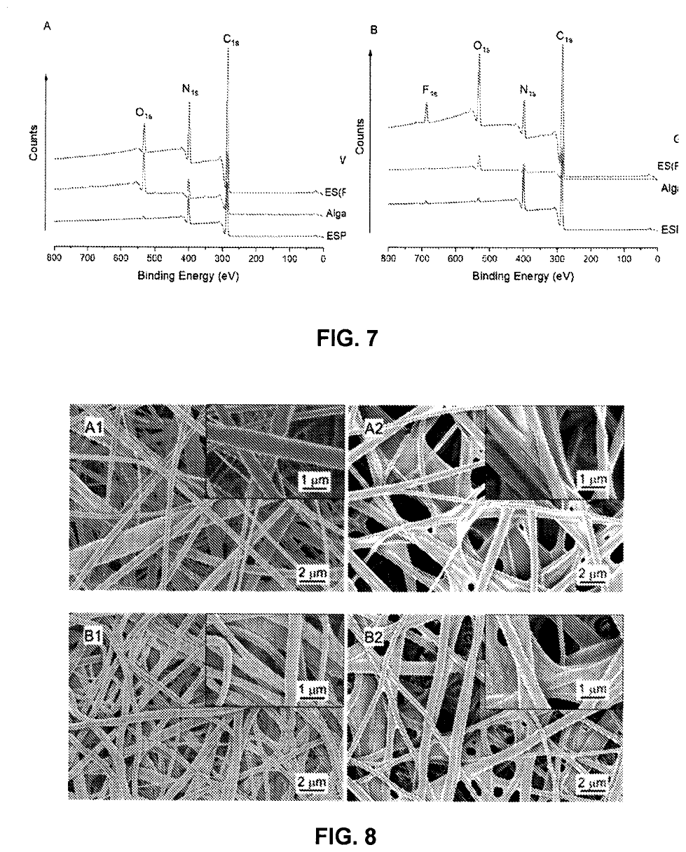

XPS was performed to analyze surface elemental composition and bonding of respective adsorbent after GenX adsorption (FIG. 7). After the filtration of GenX water, F1s peak appeared on XPS spectra of all the studied filter/adsorbent materials, confirming respective GenX adsorption.

To study the interaction between GenX and respective adsorbent, high resolution C₁_{_{S}} XPS spectrum was used. The C₁_{_{S}} spectrum of ESPAN nanofibrous membrane could be deconvoluted into three peaks, i.e., 284.8 eV, 286.46 eV and 288.16 eV, corresponding to C—H/C—C, C≡N, and C═O, respectively. After GenX adsorption, the C≡N peak shifted −0.22 eV and the C═O peak shifted −0.67 eV, respectively. The lower binding energy suggested that there is an interaction between GenX and PAN molecules. Specifically, the strong polar C—F bonds in GenX molecules (C(δ+)—F(δ−)) could form dipole-dipole interaction with the strong polar nitrile groups (C(δ+)═N(δ−)) as well as with the strong polar carbonyl groups (C(δ+)═O(δ−)) in PAN molecules. This dipole-dipole interaction could increase the electron shielding effect on Cis and thus reduce its binding energy. The high-resolution Cis spectrum of algae particles could be deconvoluted into four major peaks, i.e., 284.8 eV, 286.36 eV, 287.67 eV and 289.42 eV, corresponding to C—C/C—H, C—N/C—O, C═O and O—C═O. The binding energies of C—N, C═O, and O—C═O after GenX adsorption shifted towards lower end, i.e., to 286.08 eV, 287.35 eV, and 288.49 eV, respectively, suggesting an interaction between algae particles and GenX due to dipole-dipole interaction between these polar groups and C—F bonds of GenX molecules as well as possible hydrogen bonding between C—(N—H), C═O(N—H) and C═O(O—H) on algal surface and C═O/C—O—C in GenX molecules, which increased electron shielding effect on Cis and reduced C₁_{_{S}} binding energy. The high-resolution Cis spectrum of ES (PAN/Algae) nanofibrous membrane could be deconvoluted into four major peaks, i.e., 284.8 eV, 285.84 eV, 286.93 eV and 287.69 eV, corresponding to C—C/C—H, C≡N, C—N/C—O, and C═O, respectively. It is noteworthy that the binding energies of C≡N and C═O shifted −0.62 eV and −0.47 eV, respectively, compared to those of ESPAN nanofibrous membrane, indicating an interaction between PAN and algae in the bicomponent nanofibrous membrane and specifically through dipole-dipole interactions between strong polar nitrile functional groups (C≡N) and algal surface functional groups (C═O). After GenX adsorption, the binding energy of C≡N further shifted −0.29 eV and the binding energy of C—N/C—O shifted −0.21 eV while the binding energy of C═O shifted +0.6 eV, all of which could be attributed to the attachment of GenX molecules to the adsorbent surface. The introduction of GenX might have broken the previous dipole-dipole interaction between C═O and C—N and resulted in a binding energy increase of C═O.

### Overall Discussion

ES (PAN/Algae) nanofibrous membrane showed excellent performance in GenX adsorption at pH 6. At this pH, GenX molecules mostly exist with a negatively charged ionic end (—COO⁻) in water according to the pKa of GenX (3.82) and Henderson-Hasselbalch equation (Hopkins et al, “Recently detected drinking water contaminants: GenX and other per- and polyfluoroalkyl ether acids,” Journal AWWA, 2018, 110, 13-28; Turner et al, “Novel remediation of per- and polyfluoroalkyl substances (PFASs) from contaminated groundwater using Cannabis Sativa L. (hemp) protein powder,” Chemosphere, 2019, 229, 22-31). The main GenX adsorption mechanism of the ES (PAN/Algae) nanofibrous membrane should not be caused by electrostatic interaction under this condition because of the repulsive force between negative charge-bearing GenX molecules (—COO⁻) and negative surface charge of the nanofibers according to their large negative zeta potential (FIG. 4). Based on the FTIR and XPS analysis, it is evident that the adsorbed GenX molecules have dipole-dipole interactions with the adsorbent material. Along with the water contact angle results, it is suggested that hydrophobic interaction should be the predominant adsorption mechanism for the ES (PAN/Algae) nanofibrous membrane. To verify this hypothesis, GenX removal efficiency test was performed following the same procedure as described before but with NaCl in GenX water. It has been demonstrated from previous report (Xin et al, “Polypyrrole nanofibers as a high-efficient adsorbent for the removal of methyl orange from aqueous solution,” Journal of Environmental Chemical Engineering, 2015, 3, 1637-1647) that addition of NaCl to aqueous solution could generate an electrostatic screening effect that significantly reduce adsorption capacity of the adsorbent if the adsorption is due to electrostatic force between adsorbent surface and adsorbate ions. Specifically, 100 mg/L GenX water with 58.44 mg/L NaCl was used to test GenX removal efficiency of ES (PAN/Algae) nanofibrous membrane. The presence of NaCl, however, did not reduce the GenX removal efficiency of the ES (PAN/Algae) nanofibrous membrane, which confirmed that the adsorption of GenX by ES (PAN/Algae) nanofibrous membrane is ascribed to non-coulombic interactions including hydrophobic interaction, dipole-dipole interaction, and hydrogen bonding. Due to hydrophobic interaction, the hydrophobic ends of GenX molecules approach the ES (PAN/Algae) nanofibrous membrane followed by dipole-dipole interactions between C—F (GenX) and C—N(PAN) and between C—F (GenX) and C═O (algae) as well as hydrogen bonding between C═O (GenX) and N—H/O—H (algae). Due to the homogeneous distribution of fine algal pieces in PAN nanofibers through sonication and electrospinning, there was more algal surface that could be exposed to water in the case of GenX water filtration with ES (PAN/Algae) nanofibrous membrane, which resulted in a synergistic effect for highly effective GenX remediation from water.

### CONCLUSION

In summary, alga was demonstrated as an effective enhancer to be incorporated in electrospun PAN nanofibers to develop high-performance adsorbent/filter materials to remediate short-chain PFAS from water. An exciting synergistic effect for GenX (a popular short-chain PFAS) remediation from water was revealed by integrating 50 wt. % of chlorella algae with PAN in the form of nanofibrous membrane through electrospinning (ES (PAN/Algae)) and a 72% GenX removal efficiency was observed from gravity filtration of 100 mL 100 mg/L GenX water at pH 6 by using the prepared ES (PAN/Algae) nanofibrous membrane as filter. The maximum GenX removal capacity was ˜0.9 mmol/g, which is significantly higher than that of ESPAN nanofibrous membrane and other reported GenX adsorbents as well as activated carbon. While not wishing to be bound to any particular theory, this could be attributed to homogeneous distribution of fine algal pieces in PAN nanofibers through sonication and electrospinning, which may enable much more algal surface to be exposed to adsorb GenX in water. GenX adsorption of ES (PAN/Algae) mainly follows non-coulombic interactions including hydrophobic interaction, dipole-dipole interaction, and hydrogen bonding.

### Example 2

### Materials

Cellulose acetate (CA, Mw=˜30000), dimethyl acetamide (DMAc, 99%), acetone (99%), and NaOH pellets were purchased from Sigma-Aldrich. Soy Protein Isolate (SPI) was purchased from Fisher Scientific. GenX was purchased from SynQuest Laboratories. All materials were used as received.

### Preparation of Cellulose Acetate (CA) and Cellulose (CE) Nanofibrous Adsorbents

A 17 wt. % of CA electrospinning solution was prepared by dissolving CA in 2:1 (wt.) acetone/DMAc with stirring for 24 h. The as-prepared solution was loaded to a 10 ml syringe which was connected to an 18 g blunt needle. The distance from collector to tip of the needle was maintained at 15 cm. Flow rate of the electrospinning solution was maintained at 0.8 ml/h by a syringe pump. A high voltage of 25.4 kV was applied in the process of electrospinning. CA nanofibrous adsorbent was obtained by collecting CA nanofibers in form of non-woven mat on a motorized metal plate collector which was covered by aluminum foil. CE nanofibrous adsorbent was prepared through deacetylation of CA by soaking CA nanofibrous adsorbent in 0.05 M NaOH solution for 24 h. The obtained CE nanofibrous adsorbent was then rinsed thoroughly in DI water until pH became neutral and left in fume hood to air-dry.

### Dip-Coating Soy Protein Isolate on CA and CE Nanofibrous Adsorbents

SPI was dispersed in DI water at 1 wt. % by stirring at room temperature for 24 h. The CA and CE nanofibrous adsorbents were immersed in the SPI solution for 10 min, respectively. The corresponding nanofibrous adsorbents were then taken out of SPI solution and placed in DI water for 1 min to clean their surface. The coated nanofibrous adsorbents were air-dried in fume hood at room temperature.

### Material Characterization

Surface morphology of the nanofibrous adsorbents was examined by a Zeiss Auriga FIB field emission scanning electron microscope (SEM). Before analysis, SEM samples were sputter-coated with gold-palladium at a thickness of 8 nm to avoid surface charge accumulation. Average The average fiber diameter of each sample was obtained by measuring diameters of 30 random selected nanofibers in SEM images using Image J software. Chemical bonding in the nanofibrous adsorbents was characterized by an Agilent Varian 670 FTIR-ATR spectrometer. Surface charge of the nanofibrous adsorbents was determined by a Malvern Zeta sizer ZEN3600 dynamic light scattering instrument. Surface property (water contact angle) of the nanofibrous adsorbents was assessed by a Rame Hart 260-F4 tensiometer. Surface elemental information of the nanofibrous adsorbents before and after GenX adsorption was studied by using a Thermo Scientific Escalab Xi+X-ray photoelectron spectrometer (XPS). The elements were recorded according to the following sequence C1s, O1s, N1s, and F1s. Charging correction was performed by using C1s binding energy at 284.8 eV. High-resolution XPS peak fitting was carried out through the built-in Avantage XPS software by means of Gaussian-Lorentzian curve-fitting.

### GenX Removal Test

GenX removal efficiency of all the nanofibrous adsorbents was accessed by a filtration set up at room temperature as disclosed in Example 1. Generally, 100 mL 100 ppm (100 mg/L) model GenX solution in DI water was prepared at each of pH=4 and pH=6. The pH of the solution was adjusted by using dilute HCl or NaOH aqueous solution and monitored by an Orion pH meter. The nanofibrous adsorbent (0.024 g) was cut into a circular shape to cover the porous bottom of the filtration funnel. The 100 mL GenX model solution was poured into the funnel and allowed to flow through the nanofibrous filter via gravity. After filtration, 10 ml of the filtered solution was placed in a polypropylene (PP) centrifuge tube and subjected to centrifuge at 10,000 rpm for 30 min, generally to remove nanofibers from the solution. One ml of the resultant supernatant was transferred into a quartz cuvette for GenX concentration measurement using a Genesys 10S UV-Vis spectrometer at wavelength of 190 nm through a calibration curve.

The percentage removal of GenX was calculated using equation (1) (see Example 1). For each sample, the GenX removal test was performed three times, and results were reported as an average ±standard deviation.

### Results

### Morphology and Surface Properties

Cellulose acetate (CA) nanofibrous adsorbents showed a range of fiber sizes with an average diameter of approximately 800 nm while cellulose (CE) nanofibrous adsorbent exhibited relatively uniform fiber sizes with an average diameter of approximately 500 nm (FIG. 8: A1 & B1). The surface of CE nanofibers is rough compared to CA nanofiber surface. Without being bound by theory, the size shrinkage and rough surface of CE nanofibers could be attributed to the deacetylation reaction. The coating of soy protein isolate (SPI) does not change the size of CA or CE nanofibers appreciably (FIG. 8: A2 & B2) but does introduce some thin films in between nanofibers in both cases. CE nanofibers showed more roughness on the surface after coating. The coating of SPI was verified by FTIR; the FTIR spectra of SPI-coated CA and CE nanofibrous adsorbents (CA-SPI and CE-SPI) showed both the corresponding characteristic peaks of SPI and CA/CE, indicating successful coating of SPI on CA and CE, respectively.

The CA nanofibrous adsorbent before coating SPI was hydrophobic (water contact angle ˜105°) while it exhibited hydrophilic surface (water contact angle ˜75°) after being coated with SPI, which is close to the water contact angle of SPI film (70°). The CE nanofibrous adsorbent before coating SPI was super hydrophilic (water contact angle <10°) whereas it showed hydrophobic surface (water contact angle ˜ 110°) after SPI coating. Because of smooth surface of nanofibers as well as smooth inter-fiber SPI thin films in the CA nanofibrous adsorbent after coating with SPI, the CA-SP nanofibrous adsorbent overall acted like a SPI film from point of view surface property. Without being bound by theory, CA-SPI therefore showed a water contact angle like SPI film. Compared to CA counterpart, CE nanofibers as well as inter-fiber SPI thin films in the case of CE-SPI nanofibrous adsorbent possessed very rough surface, which without being bound by theory, could help explain the increased water contact angle.

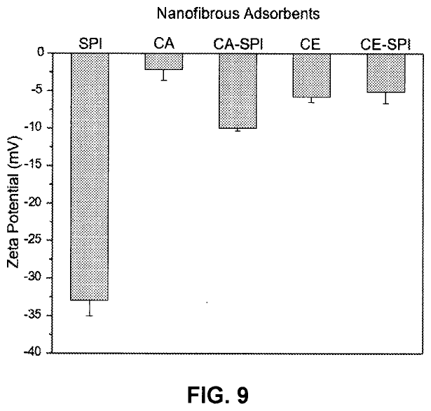

Experimental results of zeta potential showed that SPI as well as CA and CE nanofibers with and without SPI coating were all negatively charged in water (FIG. 9). The SPI possessed much higher negative charges than all nanofibrous samples. The smaller negative charge of CA than CE suggests that the SPI coating on CA nanofibrous adsorbent could be more uniform than that on CE nanofibrous adsorbent due to less negative charge repulsion between SPI and CA nanofibers. After being coated with SPI, the negative charge of CA increased significantly towards that of SPI.

GenX Remediation from Water

Quantitative adsorption tests of GenX of all the nanofibrous adsorbents were carried out at two pHs (pH=4 and 6) by using UV absorption. Calibration curves were acquired at pH=4 and 6, respectively, with different concentrations of GenX ranging from 10 to 100 mg/L. The UV absorbance of GenX at 189-190 nm fitted its concentration linearly with coefficient of determination R²=0.99.

Morphology after GenX Adsorption

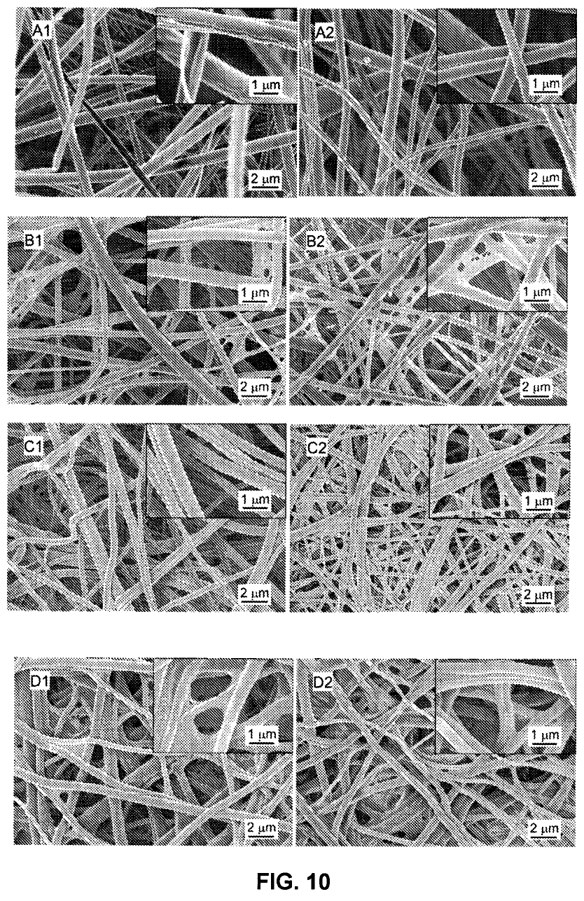

All the nanofibrous adsorbents kept their fibrous morphology after GenX adsorption (FIG. 10). CA and CE nanofibrous adsorbents did not show any appreciable change on their fibrous morphology. However, both SPI-coated CA and CE nanofibrous adsorbents (CA-SPI & CE-SPI) exhibited reduced inter-fiber films after GenX adsorption. The samples CA-SPI and CE-SPI presented more roughness and less roughness, respectively, compared to their un-coated counterparts (CA & CE). This roughness change became more significant at pH=6. Both the reduced inter-fiber film and the surface roughness change of CA-SPI and CE-SPI after adsorption of GenX indicated some loss of SPI coating in the filtration process.

### GenX Removal Efficiency

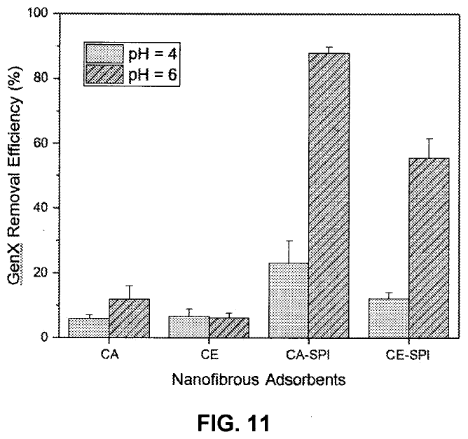

Both CA and CE nanofibrous adsorbents showed similar level of capability to remove GenX from water while CA nanofibrous adsorbent performed a little better at pH=6 (FIG. 11). The GenX removal efficiency of CA and CE nanofibrous adsorbents is similar (˜10%) as that of polyacrylonitrile (PAN) nanofibrous adsorbent at pH=6 but lower than that of PAN nanofibrous adsorbents at pH=4. After being coated with SPI, GenX removal efficiency was greatly improved for both CA and CE especially at pH 6. The maximum GenX removal efficiency, ˜88%, from 100 mL 100 mg/L GenX solution was observed by using the CA-SPI nanofibrous adsorbent at pH 6. The maximum GenX removal capacity (i.e. weight normalized GenX removal) was ˜1.1 mmol/g, which is significantly higher than that of most published GenX adsorbents and approximately ˜40% higher than granular activated carbon (GAC) and powdered activated carbon (PAC).

To verify GenX removal of nanofibrous adsorbents, XPS was performed on nanofibrous adsorbents after GenX adsorption at pH=6. Observation of F₁_{_{S}} peak after GenX adsorption confirmed that GenX was adsorbed on all nanofibrous adsorbents. Indeed the adsorption of CA and CE nanofibrous adsorbents increased significantly after SPI coating, consistent with the GenX adsorption in FIG. 11. Since assessment of GenX removal performance was done through a practical filtration setup, final GenX removal efficiency of nanofibrous adsorbents WAS determined by a combination of multiple factors such as surface property, interaction between adsorbent surface and GenX molecules as well as their interaction time through filtration. CA has a larger water contact angle and consequently more hydrophobic interaction with GenX molecules than CE. CE nanofibrous adsorbent showed superhydrophilic surface and water could pass through the adsorbent much faster than other nanofibrous adsorbents, leading to insignificant pH effect for CE. SPI coating on nanofiber surface improves GenX adsorption. Compared to CE nanofibrous adsorbent, CA nanofibrous adsorbent formed better SPI coating and possessed overall smaller water contact angle after SPI coating, both of which ensured better GenX removal performance of SPI-CA nanofibrous adsorbent than SPI-CE nanofibrous adsorbent. The isoelectric point of SPI is between pH=4 and 5, under which SPI has the minimal solubility in water. Without being bound by theory, at this pH, SPI molecules may lose their structural configuration to bind GenX molecules, which may explain why SPI-coated nanofibrous adsorbents performed less efficiently at pH 4.

### GenX Removal Mechanism

Considering GenX adsorption performance of all the nanofibrous adsorbents, GenX removal mechanism at pH=6 was studied through both experiment and simulation. At pH=6, the percentage ionization of GenX in water is more than 99% according to the pKa of GenX and Henderson-Hasselbalch equation. In this case, GenX molecules mostly exist with an ionic end of —COO⁻.

Both FTIR and XPS indicated interaction between the adsorbents and GenX molecules while the adsorbents exhibited some capacity to adsorb GenX from water. This indicated that the main interaction between GenX molecules and CA/CE substrate was non-Coulomb interactions including dipole-dipole interaction and hydrogen bonding.

### Interaction Between GenX and SPI-Coated CA and CE Nanofibrous Adsorbents

In the case of SPI-coated CA and CE nanofibrous adsorbents, the main interaction between the nanofibrous adsorbents and GenX is expected to be between SPI and GenX. FTIR results showed that one GenX peak at 604 cm⁻¹ appeared in FTIR spectra of CE-SPI while two GenX peaks (1396 cm⁻¹ and 1311 cm⁻¹) appeared in FTIR spectra of CA-SPI after GenX adsorption. In the case of CA-SPI, the N—H stretching (3280 cm⁻¹) as well as amide I and II bands shifted to lower wavenumber, consistent with hydrogen bonding between GenX molecules and H—N< in SPI. In the case of CE-SPI, the N—H stretching (3291 cm⁻¹) shifted to higher wavenumber while amide II band shifted to higher wavenumber as well, consistent with the interaction between GenX molecules and H—N< in SPI. H—N< formed large amount hydrogen bonding with HO— from CE upon coating. After contacting with GenX, the interaction between H—N< and GenX broke hydrogen bonding between HO— and H—N< and make the N—H stretching shift toward higher wavenumber. The break of hydrogen bonding also influenced the amide II band, which derives mainly from in-plane N—H bending; it shifted toward higher wavenumber,

The high-resolution Cis spectra of SPI-coated CA nanofibrous adsorbent from the control were deconvoluted into three major peaks, i.e. 284.8 eV, 286.4 eV, and 288.9 eV, corresponding to C—C/C—H, C—N/C—O, and N—C═O, respectively. The binding energy of C—N and N—C═O after GenX adsorption shifted to 286.1 eV and 288.4 eV, i.e. −0.3 eV and −0.5 eV change, respectively, suggesting the interaction between SPI and GenX. When the negative-charged −COO⁻ from GenX molecules approached to —C—NH₂/—C—NH₃⁺ and >N—C═O from SPI molecules, it might increase electron shielding effect on Cis of C—N and >N—C═O and thus reduce its binding energy. Similarly the high-resolution Cis spectra of SPI-coated CE nanofibrous adsorbent from the control were also deconvoluted into three major peaks, i.e. 284.8 eV, 286.4 eV, and 288 eV, corresponding to C—C/C—H, C—N/C—O, and N—C═O, respectively. The binding energy of C—N and N—C═O after GenX adsorption shifted to 286.2 eV and 287.9 eV, i.e. −0.2 eV and −0.1 eV change, respectively, suggesting the interaction between SPI and GenX. The binding energy change of Cis is similar as that in the case of CA-SPI but with a smaller value. As mentioned above, break of hydrogen bonding between HO— from CE and H—N< from SPI could weaken the increase of electron shielding effect of C₁_{_{S}} of C—N and >N—C═O upon GenX molecule approaching.

### Computational Analysis

To further understand the interaction between GenX and nanofibrous adsorbents, molecular dynamics (MD) simulation was performed for binding affinities between GenX and CA (GenX-CA), between GenX and CE (GenX-CE), and between GenX and SPI, respectively. Because the main component of SPI is β-conglycinin and glycinin, the computational analysis for the interaction between GenX and SPI was performed by doing simulation between GenX and β-conglycinin and between GenX and glycinin, respectively. Protein-GenX docking was performed and the highest-ranked poses from the docking results were used for MD simulation while simulations for CA-GenX and CE-GenX were completed without docking. The estimated binding affinities (Table 2) indicated that SPI has much higher binding affinity with GenX than that of CA or CE while Coulomb interaction played a more important role in SPI-GenX interaction than non-Coulomb interaction. Although the SPI showed overall negative charges, which is not in favor of Coulomb interaction with the negatively charged GenX molecules at pH=6, without being bound by theory, the Coulomb interaction could arise from the local positively charged sites (e.g. —NH₃+) in the SPI molecules and negatively charged —COO⁻ GenX molecules. The docking sites on SPI molecule from MD simulation indicated the presence of functional groups with possible positive charge formation (e.g. —NH₂).

To verify the Coulomb interaction between SPI-coated nanofibrous adsorbents and GenX, GenX removal efficiency test was performed following the same procedure as described above but with NaCl in GenX model solution. Na⁺ and Cl⁻ ions are expected to shield charge interactions between SPI and GenX molecules. In this example, 100 mg/L GenX model solution with 58.44 mg/L NaCl was used. The presence of NaCl reduced GenX removal efficiency from 88% to 28% (˜68% reduction) for CA-SPI adsorbent and from 56% to 21% (˜63% reduction) for CE-SPI adsorbent. Without being bound by theory, the reduction in GenX removal efficiency in the presence of NaCl could be attributed to the reduced Coulomb interaction between SPI and GenX molecules upon shielding effect from Na⁺ and Cl⁻ ions. The remaining GenX removal capacity could be from non-Coulomb interaction between GenX and SPI through hydrogen bonding and hydrophobic interactions.

TABLE 2
Estimated binding affinities between GenX and CA/CE/SPI

| | Binding | Coulomb | Non-Coulomb |
|---|---|---|---|
| | energy | contribution | contribution |
| Materials | (kJ/mol) | (kJ/mol) | (kJ/mol) |
| CA | −1.86 | −2.42 | −14.5 |
| CE | −0.8 | −3.61 | −16.6 |
| Glycinin | −13.3 | −127.8 | −19.2 |
| Beta-conglycinin | −10.4 | −217.9 | −16.7 |

Shown herein is, in one embodiment, a sustainable way to prepare high-efficiency filter/adsorbent materials from cellulose and its derivatives for scalable GenX remediation from water. Electrospun cellulose acetate (CA) or electrospun cellulose (CE) nanofibrous membrane alone showed similar limited GenX adsorption capacity from water, i.e. ˜0.1 mmol/g. Without being bound by theory, it is likely through mainly non-Coulomb interactions including hydrogen bonding and dipole-dipole interaction. A functional layer of soy protein isolate (SPI) on CA and CE nanofibrous membranes was successfully realized by dip coating as evidenced by hydrogen bonding between CA (C═O) and SPI (N—H) and between CE (—OH) and SPI (C═O(N—H)). The SPI coating greatly promoted GenX removal efficiency of the nanofibrous filter/adsorbent materials from water without sacrificing sustainability. The maximum GenX removal efficiency, ˜88%, from 100 mL 100 mg/L GenX solution was observed with SPI-coated CA (CA-SPI) nanofibrous membrane at pH=6 with the maximum GenX removal capacity (i.e. weight normalized GenX removal) of ˜1.1 mmol/g, which is significantly higher than that of most published GenX adsorbents and at least 40% higher than the conventional adsorbents of granular activated carbon (GAC) and powdered activated carbon (PAC). Coupling of the ultra-high specific surface area of electrospun CA and/or electrospun CE nanofibers with strong interaction between the soy protein isolate coating and GenX was shown to be highly efficient cellulose-based nanofibrous membranes, effective as filter/adsorbent materials substantially reducing GenX from water. These sustainable filter/adsorbent materials can be used for short-chain PFAS remediation, particularly in high-concentration GenX industrial wastewater and spills of such wastewater or spills of GenX itself into the environment.

### Example 3

In this example, chemical bonding was introduced between SPI coating and cellulose nanofibers using (3-glycidyloxypropyl) trimethoxysilane (GPTMS) as a linker between the cellulose and SPI.

### Reaction on Cellulose Nanofibers

A 2M NaOH aqueous solution was added to 100 ml of deionized water (DI) until pH 11 was achieved. Then 5 g GPTMS was added and the mixture was stirred vigorously for 10 min at room temperature. Next 1 g of cellulose nanofibers was added to the solution and stirred at 50 rpm in a rotary shaker for ˜ 2 hrs. The nanofibers were removed from the reaction, rinsed with DI water five times, and then rinsed in ethanol to remove excess GPTMS. The resultant GPTMS functionalized cellulose nanofibers (“G-CE”) were dried in a fume hood at room temperature. Without being bound by theory, treating cellulose nanofibers with GPTMS induces a transition from hydrophilicity to hydrophobicity.

Reaction with SPI

The chemical reaction between G-CE and SPI generally followed the synthesis disclosed in Zhang et al., “Soy protein isolate-based films reinforced by surface modified cellulose nanocrystal,” Industrial Crops and Products, 2016, 80, 207-213. Specifically, 0.2 g of glycerol, serving as plasticizer, was added to a 1 wt. % SPI solution. Subsequently, G-CE were immersed in the solution for 1 hr and subjected to thermal treatment in an oven at 105° C. for 1 hr. The nanofibers were then stored in the desiccator for further use and referred to as Crosslinked CE-SPI.

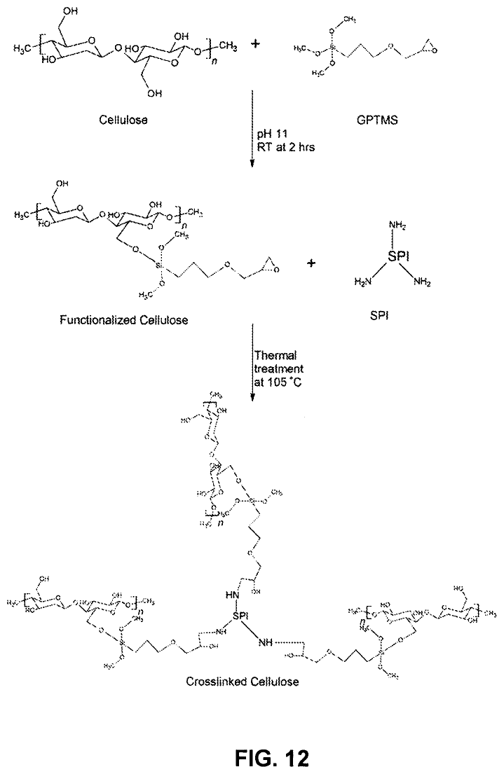

The reaction mechanism to chemically bond SPI to the surface of cellulose nanofibers is illustrated in FIG. 12.

### Reusability Test

The crosslinked CE-SPI nanofibrous adsorbent/filter membrane was subjected to a reusability test and the result was compared with the CE-SPI nanofibrous adsorbent/filter membrane (without crosslinking). Specifically, 100 ppm of a pH 6 GenX solution was poured into the filtration setup described previously with the crosslinked CE-SPI as filter and the solution was allowed to pass freely under gravity. The filtered solution was then centrifuged, and 1 ml of the supernatant was evaluated by UV spectroscopy to measure the GenX removal efficiency according to the established calibration curve.

The nanofibrous membrane was then washed with 0.05M NaOH at 65° C. for approximately 1 hr; then washed with DI water and dried in the fume hood until a constant weight was achieved. Once the nanofiber membrane was dried, the filtration test was repeated as described herein and the GenX removal efficiency was measured.

The washing and drying steps were repeated another time, followed by the filtration test and GenX removal efficiency was again measured.

### Results and Discussion

### Surface Morpholoqy

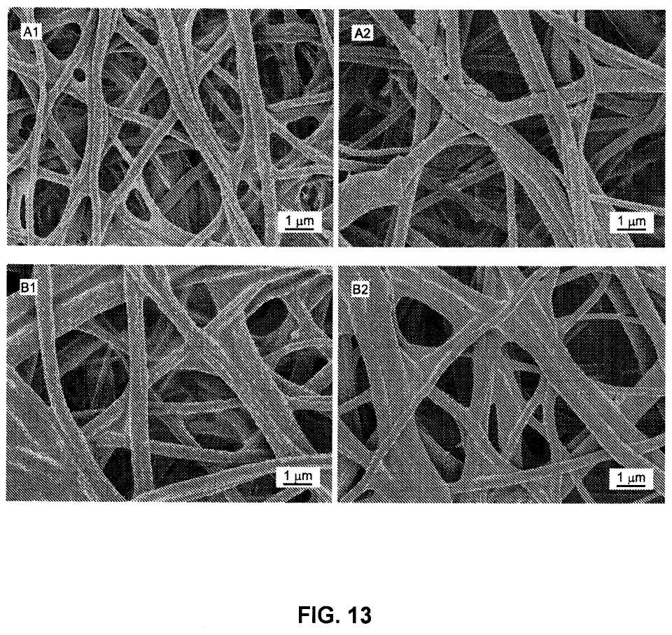

The morphology of CE-SPI (simply dip-coating) nanofibrous membrane and crosslinked CE-SPI nanofibrous membrane before the first use and after the third use is compared in FIG. 13. After three filtrations, the CE-SPI showed significant material loss compared to the crosslinked CE-SPI. Particularly, the thin films between nanofibers still are evident in the crosslinked CE-SPI.

### GenX Removal Efficiency

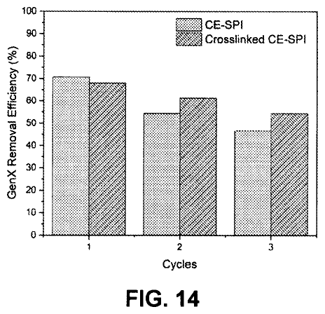

During the first use, the CE-SPI nanofibrous membrane showed ˜71% GenX removal efficiency while the crosslinked CE-SPI nanofibrous membrane showed GenX removal efficiency of ˜68%. However, the crosslinked CE-SPI nanofibrous membrane outperformed CE-SPI in GenX removal efficiency during the second use and the third use. The improvement was 13% and 17%, respectively (FIG. 14). GenX removal efficiency as well as SEM images proved the benefit of strongly bonded SPI coating on cellulose nanofibrous membrane after multiple uses, leading to improved reusability.

It will be understood that various details of the presently disclosed subject matter may be changed without departing from the scope of the presently disclosed subject matter. Furthermore, the foregoing description is for the purpose of illustration only, and not for the purpose of limitation.

1. A method of removing a polyfluoroalkyl substance and/or perfluoroalkyl substance (PFAS) from water comprising contacting water including the PFAS to a nanofibrous composition comprising algae and/or soy protein isolate, thereby removing the PFAS from the water.

2. The method of claim 1, wherein said nanofibrous composition further comprises a polymer, cellulose, and/or cellulose acetate.

3. The method of claim 1, wherein the nanofiber is prepared by electrospinning a spin dope comprising algae and a polymer.

4. The method of claim 1, wherein the algae has a protein content of at least 50%.

5. The method of claim 4, wherein the algae is Chlorella, Spirulina, or a combination thereof.

6. (canceled)

7. (canceled)

8. The method of claim 5, wherein the algae is a dried powder.

9. The method of claim 2, wherein the polymer is polyacrylonitrile or polystyrene.

10. The method of claim 2, wherein the polymer is polystyrene.

11. The method of claim 1, wherein the nanofibrous composition comprises electrospun cellulose or electrospun cellulose acetate.

12. The method of claim 1, wherein the nanofibrous composition comprises cellulose acetate nanofibers.

13. The method of claim 1, wherein the nanofibrous composition comprises cellulose nanofibers.

14. The method of claim 12, wherein the nanofibers are coated in soy protein isolate, wherein the soy protein isolate is bound to the nanofibers, optionally wherein the soy protein isolate is applied by dip coating the nanofibers in a solution comprising the soy protein isolate.

15. The method of claim 13, wherein the nanofibers are (3-glycidyloxypropyl) trimethoxysilane (GPTMS) functionalized cellulose nanofibers.

16. The method of claim 14, wherein the soy protein isolate is applied by dip coating the nanofibers in a solution comprising the soy protein isolate.

17. The method of claim 1, wherein PFAS comprises an ultra-short chain PFAS having less than 4 carbons in its chemical formula, a short chain PFAS having 4-6 carbons in its chemical formula, and/or a long chain PFAS, having more than 6 carbons in its chemical formula.

18-20. (canceled)

21. The method of any one of the previous claims, wherein said PFAS is selected from the group of hexafluoropropylene oxide-dimer acid, hexafluoropropylene oxide-dimer salt, hexafluoropropylene oxide-trimer acid, hexafluoropropylene oxide-trimer salt, hexafluoropropylene oxide-tetramer acid, hexafluoropropylene oxide-tetramer salt, perfluorooctanoic acid, perfluorooctanoate salt, perfluorooctyl sulfonate, and perfluorooctyl sulfonic acid, and combinations thereof.

22-28. (canceled)

29. The method of claim 21, wherein the salt is selected from the group of ammonium, diethanolamine, potassium, lithium, and combinations thereof.

30. (canceled)

31. (canceled)

32. The method of claim 1 wherein said method removes at least 50% of PFAS from the water.

33-37. (canceled)

38. A nanofibrous composition comprising algae and/or soy protein isolate, wherein said nanofibrous composition further comprises a polymer, cellulose, or cellulose acetate.

39-53. (canceled)

54. A method of removing one or more of a polyfluoroalkyl or perfluoroalkyl substance (PFAS) from water by exposing the water containing PFAS to the nanofibrous composition of claim 38.
